(19) United States
(12) Patent Application Publication
(10) Pub. No.: US 2006/0200412 A1
(43) Pub. Date: Sep. 7, 2006

(54) System and method for DRM regional and timezone key management

(75) Inventors: James William Fahrny, Pueblo, CO (US); Charles Compton, Bryn Mawr, PA (US)

Correspondence Address: BROOKS KUSHMAN P.C., 1000 TOWN CENTER, TWENTY-SECOND FLOOR, SOUTHFIELD, MI, 48075, US

(73) Assignee: COMCAST CABLE HOLDINGS, LLC, Philadelphia, PA (US)

(21) Appl. No.: 11/064,361

(22) Filed: Feb. 23, 2005

(51) Int. Cl. G06Q 99/00

(52) U.S. Cl. 705/50

(57) ABSTRACT

A cryptographic media stream system for ensuring media stream content is only consumed in authorized regions. The system includes at least one encryption/decryption key source configured to provide at least one of a regional key and a timezone key, where the regional key and the timezone key are globally unique keys, a media encryption engine that receives an unencrypted media stream and encrypts the encrypted media stream, and a media decryption engine that receives the encrypted media stream, and decrypts the encrypted media stream in response to at least one of the regional key and the timezone key.

### BACKGROUND OF THE INVENTION

1. Field of the Invention

The present invention relates to a system and a method for Digital Rights Management (DRM) regional and timezone encryption/decryption key management.

2. Background Art

Websites are generally accessible globally. The Uniform Resource Locator (URL, World Wide Web address) for a Website can usually be accessed from anywhere at any time. However, some streaming video media (i.e., broadcast content) have Digital Rights Management (DRM) requirements to limit the accessibility based on, for example, geographic regions such as municipality (i.e., city) and based on timezone.

In one example, news broadcasts are appropriately be viewed by select, usually local, municipalities and regions. In another example, certain sports broadcasts are “blacked out” regionally due to poor local ticket sales. In yet another example, other broadcasts are controlled by timezone. Election results are a timezone example.

Broadcast content pulls (or distributions) are known based on the regional and timezone DRM requirements. Certain content is to be distributed only to certain locations. In conventional approaches to DRM management based on the regional and timezone DRM requirements, authentications flow all the way to the respective video source. As such, conventional approaches to DRM management are extremely inefficient.

Thus, it would be desirable to have a system and a method for DRM regional and timezone key management that addresses the inefficiencies of conventional approaches and provides further enhancements to media stream distribution.

### SUMMARY OF THE INVENTION

The present invention generally provides new and innovative systems and techniques for Digital Rights Management (DRM) regional and timezone encryption/decryption key management that addresses authentication and localization substantially simultaneously without pre-positioning the content type to all locations.

According to the present invention, a cryptographic media stream system for ensuring media stream content is only consumed in authorized regions is provided. The system comprises at least one encryption/decryption key source configured to provide at least one of a regional key and a timezone key, where the regional key and the timezone key are globally unique keys, a media encryption engine that receives an unencrypted media stream and encrypts the encrypted media stream, and a media decryption engine that receives the encrypted media stream, and decrypts the encrypted media stream in response to at least one of the regional keys and the timezone keys. A simplistic way to understand the present invention is that a single key is formed by combining the regional key, the timezone key and another system key into a single master key. The media stream content can generally only be unlocked with the “master key” that is a combination of the multiple types of information contained in the respective keys.

Also according to the present invention, a method of ensuring media stream content is only consumed in authorized regions is provided. The method comprises providing at least one of a regional key and a timezone key using at least one encryption/decryption key source, wherein the regional key and the timezone key are globally unique keys, receiving an unencrypted media stream and encrypting the encrypted media stream using a media encryption engine, and receiving the encrypted media stream, and decrypting the encrypted media stream in response to at least one of the regional key and the timezone key using a media decryption engine.

Further, according to the present invention, a system for distribution, reception and display of media streams and for ensuring media stream content is only consumed in authorized regions is provided. The system comprises a source for information regarding a subscriber for authentication, at least one encryption/decryption key source configured to provide at least one of a regional key and a timezone key, wherein the regional key and the timezone key are globally unique keys, a media encryption engine that receives an unencrypted media stream and encrypts the encrypted media stream, and a media decryption engine that receives the encrypted media stream, and decrypts the encrypted media stream in response to at least one of the regional key and the timezone key, and validates the location of the subscriber for region and timezone using credentials.

The above features, and other features and advantages of the present invention are readily apparent from the following detailed descriptions thereof when taken in connection with the accompanying drawings.

### BRIEF DESCRIPTION OF THE DRAWINGS

FIG. 1 is a diagram of a media stream encoder/controller of the present invention;

FIG. 2 is a diagram of a media stream decoder/controller of the present invention; and

FIG. 3 is a diagram of a media processing and delivery system implementing the present invention.

### DETAILED DESCRIPTION OF THE PREFERRED EMBODIMENT(S)

With reference to the Figures, the preferred embodiments of the present invention will now be described in detail. In one example, the present invention may be implemented in connection with a cable television transmission and reception system. In another example, the present invention may be implemented in connection with a satellite (i.e., “dish”) broadcast television transmission and reception system (not shown). However, the present invention may be implemented in connection with any appropriate media stream transmission and reception (i.e., distribution) system to meet the design criteria of a particular application.

In the description below, the abbreviations, acronyms, terms, etc. may be defined as follows:
AES: Advanced Encryption Standard. AES is generally a much more secure algorithm to use for the storing of digital content in a digital video recording when compared to DES.
Authentication: The process of identifying an individual, usually based on a username and password. In security systems, authentication is distinct from authorization, which is the process of giving individuals access to system objects based on their identity. Authentication generally ensures that the individual or entity is who they claim to be.
Authorization: The process of granting or denying access to a network resource. Most computer security systems are based on a two-step process. The first stage is authentication, which ensures that a user is who he or she claims to be. The second stage is authorization, which allows the user access to various resources based on the identity of the user.
Credential: An object that is verified when presented to the verifier in an authentication transaction. Credentials may be bound in some way to the individual to whom they were issued, or they may be bearer credentials. The former are necessary for identification, while the latter may be acceptable for some forms of authorization. Electronic credentials can be digital documents used in authentication and access control that bind an identity or an attribute to a claimant's token or some other property, such as a current network address. Credentials are verified when presented to the verifier in an authentication transaction. Anonymous credentials are used to evaluate an attribute when authentication need not be associated with a known personal identity.
DES: Data Encryption Standard. A fixed-key-length security algorithm that employs 56-bit length keys. Any 56-bit number can be implemented as a DES key. The relatively short key length renders DES vulnerable to brute-force attack wherein all possible keys are tried one by one until the correct key is encountered (i.e., the key is “broken”).
DRM: Digital Rights Management. A system for protecting the rights of data circulated via the Internet or other digital media (e.g., satellite transmissions, cable distributions, and the like) by performing at least one of enabling secure distribution and disabling illegal distribution of the data. Typically, a DRM system protects intellectual property by either encrypting the data so that the data (e.g., a media stream) can only be accessed by authorized users or marking the content with a digital watermark or similar method so that the content can not be freely distributed.
Electronic Code Block (Mode): ECB, In ECB the message is divided into 64-bit blocks, and each block is encrypt separately. Encryption is independent for each block.
Entitlement Control Message (Stream): ECM, Messages that generally define access requirements of a program, specify the tiers required for subscription, and the cost associated with impulse purchase of the program. The index may be delivered in the ECM as a reference to the content key. Encrypted program keys may be delivered in the ECM stream.
Entitlement Management Message (Stream): EMM, Messages that define access rights for each individual decoder. The EMM stream is processed with the access control device, however, the user processor buffers EMMs and feeds them to the access control device via an interface.
Hash: A function (or process) that converts an input (e.g., the input stream) from a large domain into an output in a smaller set (i.e., a hash value, e.g., the output stream). Various hash processes differ in the domain of the respective input streams and the set of the respective output streams and in how patterns and similarities of input streams generate the respective output streams. One example of a hash generation algorithm is Secure Hashing Algorithm-1 (SHA-1). Another example of a hash generation algorithm is Message Digest 5 (MD5). The hash may be generated using any appropriate algorithm to meet the design criteria of a particular application.
Headend: The control center of a cable television system, where broadcast signals are received and distributed. The headend generally contains antennas, preamplifiers, frequency converters, demodulators, encoders, compressors, automatic switching equipment and other related equipment that receives, amplifies, filters, encrypts, encodes, and converts incoming satellite and terrestrial streams for presentation to distribution channels.
Initialization vector: IV, An initialization vector in a block cipher is a block of bits that is combined with the first block of data in any of several feedback modes. The IV will make each ciphertext unique, even when similar plain text is encrypted with the same key in chain block coding (CBC) mode.
Key: A password or table needed to decipher encoded data.
Keylist: A list of decoder addresses and respective decoder keys in ordered pairs. Keylists may be used by the Uplink Control System (UCS) for generation of authorization messages that are addressed to the diagnostic circuit that is embedded in decoders that are specific to the encoder system.
Media: Plural of medium. The form and technology used to communicate information. Multimedia presentations, for example, combine sound (e.g., audio), pictures, and videos, all of which are different types of media. Media streams generally include video, audio, video plus audio, and the like in any appropriate format or protocol such as Motion Picture Expert Group (MPEG), MPEG-2, MPEG-4, Windows Media 9, Real Media, etc.
MSO: Multiple System Operator
Program: A time contiguous collection of motion image information, audio information, or a combination thereof that is transmitted (i.e., presented, broadcast, sent, delivered, etc.) as an entity.
Program Key: An encryption/decryption key that controls access, encryption/decryption, etc. of a particular program.
STB: Set Top Box (also Decoder, Receiver, Tuner, Transceiver). A unit similar to cable boxes. The STB is capable of receiving and decoding DTV broadcasts. A STB typically converts and displays transmissions from one frequency or format such as analog cable, digital cable, satellite broadcast, digital television, etc. to a standard frequency (such as channel 3 or 4) for display on a television, monitor, and the like. A DTV ‘Certified’ STB can receive all (i.e., 18) ATSC DTV formats, (including HDTV) and provide a displayable picture. STB functionality can also be integrated into other devices including personal computers, television sets, digital video recorders (DVRs), etc.
Streaming: A technique for transferring data such that the data can be processed as a steady and continuous stream. Streaming technologies are becoming increasingly important with the growth of the Internet because most users do not have fast enough access to download large multimedia files quickly. With streaming, the client browser or plug-in can start displaying the data before the entire file has been transmitted. For streaming to work, the client side receiving the data must be able to collect the data and send the as a steady stream to the application that is processing the data and converting the data to sound or pictures. When the streaming client receives the data more quickly than required, the receiving client needs to save the excess data in a buffer. When the data does not come quickly enough, however, the presentation of the data generally will not be smooth.
Triple-DES: (3-DES) Application of DES encryption three times using three different keys or, alternatively, using a one key for the first and third segments of a three segment key and a second key for the middle segment, for a total key bit-width of 112 or 168 bits is also used to protect certain structures and the key inside entitlements.
Unit address: A unique number that identifies and distinguishes one decoder from another. One example of a unit address is a Media Access Control (MAC).
Unit key (or Private key): A key that is unique to a respective decoder. Messages intended for a particular decoder are encrypted using the respective unit key.
Unit keylist: A file that contains unit addresses and respective unit keys.
Uplink Control System (UCS): Software that is used to support the secure delivery of digitally compressed services. The UCS generally provides the capability to authorize and de-authorize individual decoders on an event-by-event basis.
UTC: Universal Time Code
Working key: A low level key that generally changes several times per second. The working key generally has a validity that is equal to or shorter in duration than the program to which it is related. The working key is also referred to as the “control word.” In one typical example, the working key changes every 20 to 30 seconds. In one example (e.g., services that do not have a video component), the working key epoch (i.e., the period of time during a program for which a working key is valid) duration may be set at an appropriate time interval. However, any appropriate time for changing the working key may be implemented to meet the design criteria of a particular application. The working key is used to derive the keystream. The working key is generally delivered in an encrypted form with the respective program key.
VOD: Video-on-Demand, an umbrella term for a wide set of technologies and companies whose common goal is to enable individuals to select videos from a central server for viewing on a television or computer screen. VOD can be used for entertainment (ordering movies transmitted digitally), education (viewing training videos), videoconferencing (enhancing presentations with video clips), and the like.
Working Key File: A file that contains the working keys for the entire program that is encrypted in the program key, generally in chronological order.

The Digital Rights Management (DRM) regional and timezone encryption/decryption key management of the present invention is generally implemented as a cryptographic system and method that may ensure that content (e.g., media streams, broadcasts, etc.) including video can only be consumed (e.g., viewed, observed, listened to, watched, recorded, played, etc.) in the appropriate (e.g., authorized, allowed, permitted, etc.) regions (e.g., municipalities, cities, states, and the like) and timezones of the distribution area (e.g., country, state, territory, etc.). There can be certain types of distributed media content such as sports events and election coverage that are generated and distributed with at least one of regional restrictions and timezone restrictions.

Multiple System Operators (MSOs) generally adhere to programming contracts and regulations that may include regional and timezone related media stream content distribution limitations. Such limitations may include, time restriction on election coverage, time restriction on information distribution to widely dispersed corporate locations, regional “black out” of sporting events due to ticket sales below a predetermined level (e.g., less than a sellout), and the like.

In streaming media and DRM technology, there are generally no inherent methods to meet the regional restriction and timezone restriction requirements placed on certain types of content. When content is placed on centralized streaming servers or delivered in real-time, the present invention generally provides a cryptographic method that generally ensures that MSOs are meeting the contract obligations based on keys that are generated and distributed corresponding to the regional content. Globally unique IDs for timezone and region may be used to generate a key for encryption at the source and the same globally unique IDs are used at the sink i.e., (receiving) device to decrypt the content for user consumption.

The DRM regional and timezone encryption/decryption key management of the present invention may provide a new, more secure, and simplified method to deliver specialized keys and license files for decrypting content and program media streams in streaming media applications. The new key management of the present invention may dramatically reduce the complexity that is implemented to restrict content keys to a region or to a timezone. The DRM regional and timezone encryption/decryption key management system and method of the present invention may be a significant portion of a new streaming media DRM system that generally ensures that regional content is only decrypted and viewed in the permitted region and timezone as required by content contracts. The DRM regional and timezone key management system and method of the present invention generally provides more efficient distribution and operations of certain types of content for streaming applications when compared to conventional approaches.

The DRM regional and timezone encryption/decryption key management of the present invention may provide flexibility and help to simplify the Impulse Pay Per View (IPPV), Video On Demand (VOD) and broadband streaming media security in a distribution system headend. The simplified key management structure of the present invention may be applied to the IPPV and VOD technologies and any appropriate broadband streaming media security and thereby standardize the overall approach to security for VOD and the like when executed through a DRM server.

The commercial value of Reduced DRM Regional and Timezone Key Management of the present invention may be very large since the present invention generally supports the Computer and Consumer Electronics (CE) industry to innovate new types of streaming services for MSOs. All CE and computer companies are potential customers for the present invention. The present invention may lower the overall cost of managing head-ends, set-tops and digital televisions, lower the cost and ease the operational complexities for Streaming Media and VOD applications, thereby providing the MSOs substantial cost savings when compared to conventional approaches. By enabling dramatically lower costs as well as increased innovation and new business models, the DRM Regional and Timezone Key Management of the present invention may improve the competitive position of cable based media distribution versus alternative video providers such as DBS and emerging telco-based video systems.

The present invention generally provides an improved system and method for generating encryption/decryption keys (e.g., DRM regional keys), and encrypting content that generally binds (i.e., associates, connects, relates, etc.) the media stream content to respective regions and timezones in the region (i.e., country, territory, user type, etc.) of interest. The system and method of the present invention generally ensure that content (e.g., data in a media stream) in the region (typically a geographic region such a metropolitan area, a state, a timezone, and the like) of interest is generally decrypted for display by consumers in specific regions and timezones in accord with MSO content contracts.

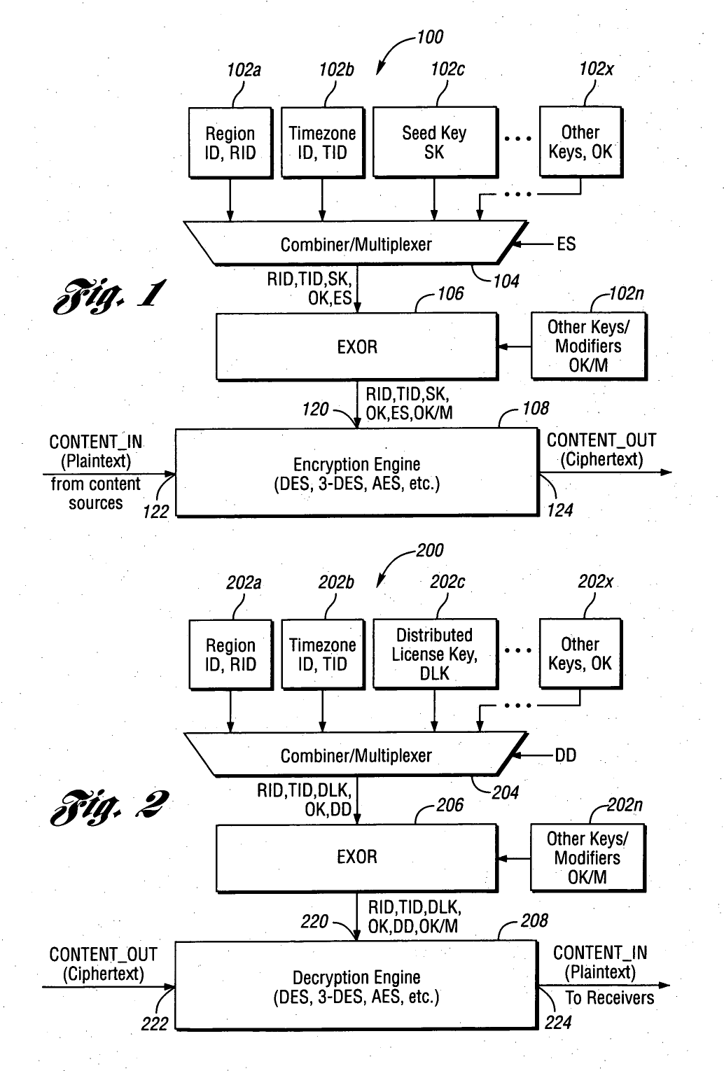

Referring to FIG. 1, a diagram illustrating an encryption system (i.e., controller) 100 of the present invention is shown. The controller 100 may provide for generation of a source (or seed) key (e.g., SK) and for encryption implemented at the centralized content distribution point where content is originated for a streaming application or content distribution network (CDN) (described in more detail in connection with FIG. 3). However, the controller 100 may be implemented at any appropriate signal, key, or media stream origination location in a media stream distribution system.

The controller 100 generally comprises at least one key source 102 (e.g., key sources 102a-102n), a combiner/multiplexer 104, an Exclusive OR (e.g., EXOR) block (i.e., at least one of a circuit, gate, firmware, software, and the like that is configured to perform a logic EXOR operation) 106, and an encryption engine 108. The key sources 102 generally provide respective encryption/decryption keys. In one example, the key sources 102 may be implemented as key generator memory having keys stored therein (e.g., look up tables, LUT), and the like), a combination of a key generator and a memory, etc. However, the key sources 102 may be implemented as any appropriate key generator or source to meet the design criteria of a particular application.

The combiner/multiplexer 104 generally has a plurality of inputs that may receive keys (e.g., RID, TID, SK, OK, and the like) from respective key sources 102, and output that may present one or more of the keys RID, TID, SK, and OK to a first input of the EXOR block 106 in response to an encryption control signal (e.g., ES). The combiner/multiplexer 104 may select or combine one or more of the keys RID, TID, SK, and OK for presentation to the EXOR block 106 in response to the encrypt stream control signal ES.

The EXOR block 106 may a second input that may receive at least one key modifier (e.g., OK/M), and an output that may present at least one of the keys RID, TID, SK, and OK, the encryption control signal ES, and the least one key modifier OK/M to an input 120 of the encryption engine 108. The EXOR block 106 may further combine at least one of the keys RID, TID, SK, and OK, and the least one key modifier OK/M, generally in response to the encryption control signal ES.

The encryption engine 108 may have an input 122 that may receive an unencrypted media stream (e.g., CONTENT_IN) from at least one (and generally a plurality of) media content sources (not shown), and an output 124 that may present an encrypted media stream (e.g., CONTENT_OUT) in response to the media stream CONTENT_IN and at least one of the keys RID, TID, SK, and OK, the encryption control signal ES, and the least one key modifier OK/M. The encrypted media stream signal CONTENT_OUT generally includes an encrypted version of the clear media stream signal CONTENT_IN and at least one of the keys RID, TID, SK, and OK, the encryption control signal ES, and the least one key modifier OK/M.

The key RID may be implemented as a region identification key (i.e., a key that is associated with a particular region, generally a geographic region). The key TID may be implemented as a timezone identification key (i.e., a key that is associated with a particular timezone). The source seed key SK may be generated by the proprietor of the media stream distribution system where the controller 100 is implemented for use in generation of additional keys (e.g., OK and OK/M) for use in DES, 3-DES, or any other appropriate encryption process.

In one example, the other keys OK may be keys that correspond to a user profile that may include demographic information such as age, gender, incarceration status, employment identification, video viewing habits, income range, product purchase interests, broadband subscriber status, phone subscriber status (e.g., standard telephone service, cellular telephone service, DSL service, fax line service, etc.), geographic location, state, place of birth, and the like. In another example, the other keys OK may be keys that correspond to time of day, sales status of a sporting event (e.g., all local tickets sold out or not sold out), etc.

In one example, the other keys and modifiers OK/M may be implemented as a video on demand (VOD) key. In another example, the other keys and modifiers OK/M may be implemented as an impulse pay per view (IPPV) key. In yet another example, the other keys and modifiers OK/M may be implemented as a working key. However, the keys OK and OK/M may be implemented as any appropriate encryption/decryption key to meet the design criteria of a particular application.

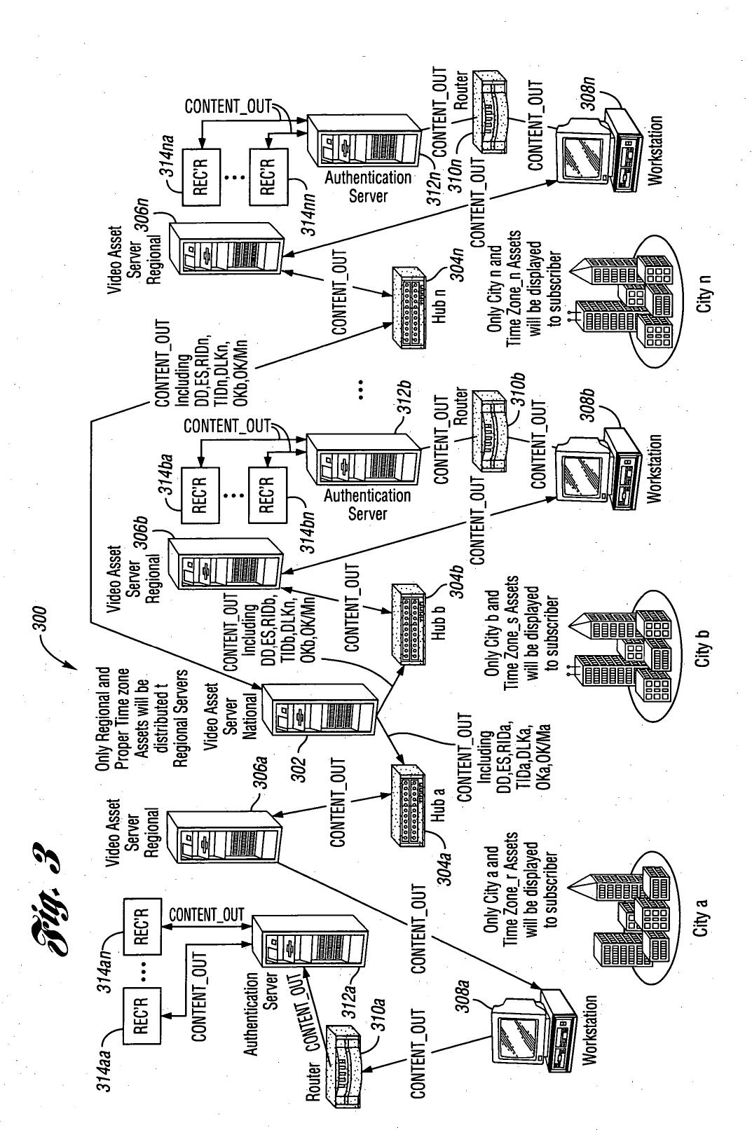

Referring to FIG. 2, a diagram illustrating decryption system (i.e., controller) 200 of the present invention is shown. The controller 200 may provide for generation of a decryption key (e.g., DD) and decryption of a received encrypted media stream (e.g., CONTENT_OUT) in an end user device (e.g., a set top box (STB), a personal computer and monitor system, a receiver having internal decryption, etc.) based on the delivery of the media stream CONTENT_OUT along the CDN to the subscriber. However, the controller 200 may be implemented at any appropriate signal, key, or media stream destination location in a media stream distribution system.

The controller 200 generally comprises at least one key source 202 (e.g., key sources 202a-202n), a combiner/multiplexer 204, an Exclusive OR (e.g., EXOR) block (i.e., at least one of a circuit, gate, firmware, software, and the like that is configured to perform a logic EXOR operation) 206, and a decryption engine 208. The combiner/multiplexer 204 generally has a plurality of inputs that may receive keys (e.g., RID, TID, DLK, OK, and the like) from respective key sources 202, and output that may present one or more of the keys RID, TID, DLK, and OK to a first input of the EXOR block 106 in response to an decryption control signal (e.g., DD). The key sources 202 are generally implemented as memories where the respective keys are loaded (e.g., when authentication certificates are installed) and stored. However, the sources 202 may be implemented as any appropriate key source to meet the design criteria of a particular application.

The combiner/multiplexer 204 may select or combine one or more of the keys RID, TID, DLK, and OK for presentation to the EXOR block 206 in response to the decrypt stream control signal DD. In one example, the control signal DD may br implemented as the control signal ES. In another example, the control signal DD may br implemented as a key signal that is provided to respective authorized users via the media stream CONTENT_OUT.

The EXOR block 206 may a second input that may receive the at least one key modifier OK/M, and an output that may present at least one of the keys RID, TID, DLK, and OK, the control signal DD, and the least one key modifier OK/M to an input 220 of the encryption engine 208. The EXOR block 206 may further combine at least one of the keys RID, TID, DLK, and OK, and the least one key modifier OK/M, generally in response to the decryption control signal DD.

The decryption engine 208 may have an input 222 that may receive an encrypted media stream (e.g., the media stream CONTENT_OUT) via the CDN to the subscriber and an output 124 that may present a decrypted (e.g., clear) media stream (e.g., CONTENT_IN) in response to the media stream CONTENT_OUT and at least one of the keys RID, TID, DLK, and OK, the decryption control signal DD, and the least one key modifier OK/M. The clear media stream CONTENT_IN is generally presented to at least one receiver (e.g., television, high definition television, personal computer and monitor, and the like) at the user location.

Referring to FIG. 3, a diagram illustrating an example media stream distribution system (e.g., a CDN) 300 implementing the present invention is shown. The system 300 of the present invention may be implemented in connection with a cable (or satellite) television delivery system. However, the present invention may be implemented in connection with any appropriate media stream delivery system to meet the design criteria of a particular application. The present invention may dis-aggregate (i.e., separate, break apart, etc.) content security algorithms (i.e., routines, processes, operations, etc.) that are typically proprietary from the respective infrastructure components (e.g., media stream delivery system headend components and set top boxes (STBs), and the like).

The system 300 generally comprises a national server 302 coupled to a plurality of hubs 304 (e.g., hubs 304a-304n). The hubs 304 are each generally coupled to respective regional servers 306 (e.g., servers 306a-306n) that generally distributes media streams to respective regions a-n (e.g., to city_a-city_n, timezone_a-timezone_n, etc.). Each regional server 306 may be coupled to a respective workstation 308 (e.g., workstations 308a-308n). Each workstation 308 may be coupled to a respective router 310 (e.g., routers 310a-310n). Each router 310 may be coupled to a respective authentication server 312 (e.g., authentication servers 312a-312n). Each authentication server 312 is generally coupled to at least one client (customer) location device (e.g., a STB, a receiver, a personal computer and monitor, etc.) 314. A such, hubs 304, servers 306, workstations 308, routers 310, servers 312, and receivers 314 are successively downstream from the preceding elements.

The system 300 generally provides media streams (e.g., media streams that include video, audio, video plus audio, and the like in any appropriate format or protocol such as Motion Picture Expert Group (MPEG), MPEG-2, MPEG-4, Windows Media 9, Real Media, etc. streams) across a plurality (i.e., at least two) regions having varying distribution implementations. The present invention may further be implemented in connection with any appropriate newly developed video compression and transport protocol. For example, media stream assets may be segregated for the various regions that comprise the system 300 (e.g., respective regions related to, corresponding to, associated with, etc. each of the servers 302, 306, and 312).

The system 300 is generally implemented such that each respective region a-n is presented respective media stream assets that are the encrypted media stream CONTENT_OUT including keys and control signals (e.g., DD, ES, RIDa, TIDa, DLKa, OKa and OK/Ma to region a; DD, ES, RIDb, TIDb, DLKb, OKb and OK/Mb to region b; and so on). The national server 302 is generally configured to distribute proper (i.e., respective) media stream assets to the regional servers 306 via hubs 204 in response to the appropriate keys and ids (e.g., DD, ES, RID, TID, DLK, OK and OK/M). As such, the system 300 generally ensures that the media stream content is decrypted in the respective regions a-n by users (i.e., clients, customers, etc.) having appropriate keys and ids for the content, and region (e.g., timezone, city, voting area, etc.).

Each of the region and timezone IDs (e.g., the identifiers associated with or implemented as the keys RID and TID, respectively) are generally implemented as a globally unique ID and are generally globally unique with respect to all other IDs that may be used in key generation through the system of encryption and decryption (i.e., the controllers 100 and 200, respectively).

The controller 100 may be implemented in connection with the server 302. At least one of the system (or controller) 100 and the system (or controller) 200 may be implemented in connection with at least one of the servers 306 and 312. Content with known headers that are encrypted in the content may be presented as the media stream CONTENT_OUT such that the decryption may be performed and values checked to ensure that the proper key (e.g., the respective keys ES and DD) was generated on both ends of the media stream distribution system and that the regional IDs (e.g., RIDa-RIDn) and timezone IDs (e.g., TIDa-TIDn) are matching. Error messages may be displayed to the end subscriber when a failure occurs rather than displaying to the subscriber streaming video comprising a set of random blocks and pixels encrypted with the wrong key. The technology implemented using the present invention generally ensures that content encrypted at the source can only be decrypted by end-users (subscribers) in the regions and timezones as permitted by the content contracts agreed to by MSOs.

The encryption system (i.e., controller) 100 and the decryption system (i.e., controller) 200 of the present invention may be implemented in any appropriate level of servers of the system 300. In one example, an encryption controller 100 may be implemented in connection with the server 302 and a decryption controller 200 may be implemented in connection with at least one of the servers 306 and 312, and the receivers 314. The keys (e.g., RID, TID, and so forth) are generally distributed to respective regions (e.g., RIDa to region a, RIDb to region b, and so forth) per the respective MSO contracts. In another example, encryption controller 100 may be implemented in connection with the server 306. In yet another example, the encryption controller 100 may be implemented in connection with the server 312. The decryption controller 200 may be implemented in connection with at least one of the servers and the receivers 314 that are downstream from the controller 100.

The present invention generally ensures, through security technology, that regional and timezone specifications for content contracts can be met. The present invention generally performs a DRM regional and timezone Key Management process as follows.
(i) Credentials (e.g., the seed key SK, the region key RID, the timezone key TID, etc.) are generally used to present information regarding (i.e., associated with, related to, corresponding to, etc.) a subscriber (i.e., client, user, customer, viewer, etc.) for authentication.
(ii) The subscriber is authenticated for access to media stream content (e.g., the media stream CONTENT_OUT).
(iii) Credential information (e.g., key value evaluation for the distributed license key DLK) is generally used to validate the location of the subscriber for region and timezone. Location information (e.g., information associated with the keys RID and TID) is generally in the certificate that is provided for a particular subscriber.
(iv) The connection location may be validated for region and timezone (e.g., the control signal DD may enable the presentation of at least one of the keys RID, TID, DLK and OK to the decryption engine 208). However, authentication is generally not performed at the video source (e.g., at the system headend 302).
(v) When the media stream content is marked (i.e., designated, identified, to be controlled, etc.) by region, authentication is generally steered to (i.e., directed to, performed at, etc.) the region as well (e.g., at a respective regional authentication server 312). In one example, centralized authentication may be performed (e.g., at a server 306), and a second tier of authentication may be performed (e.g., at the server 312, at the user receiver 314, etc.) to implement regional restrictions.

As is readily apparent from the foregoing description, then, the present invention generally provides an improved system and an improved method using new and innovative systems and techniques for DRM regional and timezone key management that addresses authentication and localization substantially simultaneously without pre-positioning the content type to all locations.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A cryptographic media stream system for ensuring media stream content is only consumed in authorized regions, the system comprising:
at least one encryption/decryption key source configured to provide at least one of a regional key and a timezone key, wherein the regional key and the timezone key are globally unique keys;
a media encryption engine that receives an unencrypted media stream and encrypts the encrypted media stream; and
a media decryption engine that receives the encrypted media stream, and decrypts the encrypted media stream in response to at least one of the regional key and the timezone key.

2. The system of claim 1 wherein the regional and timezone keys limit media stream content distribution based on at least one of time restriction on election coverage, time restriction on information distribution to widely dispersed corporate locations, and regional “black out” of sporting events due to ticket sales below a predetermined level such that Multiple System Operators (MSOs) adhere to programming contracts and regulations.

3. The system of claim 1 wherein the system is implemented in connection with Impulse Pay Per View (IPPV) and Video On Demand (VOD) security in a media stream distribution system.

4. The system of claim 1 further comprising at least one other key source that provides at least one key corresponding to user profile demographic information.

5. The system of claim 4 wherein the user profile demographic information includes at least one of age, gender, incarceration status, income range, purchase selection preferences, video viewing habits, broadband subscriber status, phone subscriber status, geographic location, place of birth, and employment identification.

6. The system of claim 1 further comprising at least one other key source that provides at least one key corresponding to video on demand (VOD) and to impulse pay per view (IPPV).

7. The system of claim 1 further comprising at least one other key source that provides a working key.

8. The system of claim 1 wherein the media stream includes at least one of video, audio, video plus audio content that are presented in at least one protocol comprising Motion Picture Expert Group (MPEG), MPEG-2, MPEG-4, Windows Media 9, and Real Media protocols.

9. The system of claim 1 wherein error messages are displayed to an end subscriber when a failure occurs rather than streaming video that is a set of random blocks and pixels encrypted with an incorrect key.

10. A method of ensuring media stream content is only consumed in authorized regions, the method comprising:
providing at least one of a regional key and a timezone key using at least one encryption/decryption key source, wherein the regional key and the timezone key are globally unique keys;
receiving an unencrypted media stream and encrypting the encrypted media stream using a media encryption engine; and
receiving the encrypted media stream, and decrypting the encrypted media stream in response to at least one of the regional key and the timezone key using a media decryption engine.

11. The method of claim 10 wherein the regional and timezone keys limit media stream content distribution based on at least one of time restriction on election coverage, time restriction on information distribution to widely dispersed corporate locations, and regional “black out” of sporting events due to ticket sales below a predetermined level such that Multiple System Operators (MSOs) adhere to programming contracts and regulations.

12. The method of claim 10 wherein the method is implemented in connection with Impulse Pay Per View (IPPV), Video On Demand (VOD) or broadband streaming media security in a media stream distribution system.

13. The method of claim 10 further comprising providing at least one key corresponding to user profile demographic information.

14. The method of claim 13 wherein the user profile demographic information includes at least one of age, gender, incarceration status, video viewing habits, broadband subscriber status, phone subscriber status, geographic location, place of birth, and employment identification using at least one other key source.

15. The method of claim 10 further comprising providing at least one key corresponding to video on demand (VOD) key and to impulse pay per view (IPPV) using at least one other key source.

16. The method of claim 10 further comprising providing a working key using at least one other key source.

17. The method of claim 10 wherein the media stream includes at least one of video, audio, video plus audio content that are presented in at least one protocol comprising Motion Picture Expert Group (MPEG), MPEG-2, MPEG-4, Windows Media 9, and Real Media protocols.

18. The method of claim 10 further comprising displaying error messages to an end subscriber when a failure occurs rather than displaying streaming video that is a set of random blocks and pixels encrypted with an incorrect key.

19. The method of claim 10 further comprising presenting information regarding a subscriber for authentication and validating the location of the subscriber for region and timezone using credentials.

20. The method of claim 19 further comprising authenticating at a location other than at a video source.

21. The method of claim 19 further comprising authenticating at a respective regional server using a second tier of authentication.

22. A system for distribution, reception and display of media streams and for ensuring media stream content is only consumed in authorized regions, the system comprising:
a source for information regarding a subscriber for authentication;
at least one encryption/decryption key source configured to provide at least one of a regional key and a timezone key, wherein the regional key and the timezone key are globally unique keys;
a media encryption engine that receives an unencrypted media stream and encrypts the encrypted media stream; and
a media decryption engine that receives the encrypted media stream, and decrypts the encrypted media stream in response to at least one of the regional key and the timezone key, and validates the location of the subscriber for region and timezone using credentials.
